(19) United States
(12) Patent Application Publication
(10) Pub. No.: US 2008/0099254 A1
(43) Pub. Date: May 1, 2008

(54) POSITION-DETECTING APPARATUS AND POSITION-INDICATING DEVICE

(76) Inventor: Yuji KATSURAHIRA, Kazo-city (JP)

Correspondence Address: BERENATO, WHITE & STAVISH, LLC, 6550 ROCK SPRING DRIVE, SUITE 240, BETHESDA, MD, 20817, US

(21) Appl. No.: 11/924,870

(22) Filed: Oct. 26, 2007

(30) Foreign Application Priority Data
Oct. 31, 2006 (JP) 2006-296511

(51) Int. Cl. G06F 3/041

(52) U.S. Cl. 178/18.01

(57) ABSTRACT

A position-detecting apparatus includes a tablet for transmitting an electromagnetic wave and a position-indicating device for generating a transmission signal based on the electromagnetic wave received from the tablet. The position-detecting apparatus detects a position on the tablet indicated by the position-indicating device. The position-detecting device includes: a resonance circuit having a coil and a capacitor, a power supply extraction unit, an information reply unit, and a voltage conversion unit configured to generate a second power supply having a predetermined voltage level which is lower than a first power supply extracted by the power supply extraction unit.

### CROSS REFERENCES TO RELATED APPLICATIONS

The present invention claims priority from Japanese Patent Application JP 2006-296511 filed in the Japanese Patent Office on Oct. 31, 2006 under 35 U.S.C. 119, contents of which are incorporated herein by reference.

### FIELD OF THE INVENTION

The present invention relates to a position-detecting apparatus and a position-indicating device for a digitizer tablet, which can be connected to a computer and configured to generate a strong reply signal depending on a transmission from the tablet during the detection of a position of the position-indicating device using an electromagnetic induction system.

### BACKGROUND OF THE INVENTION

In recent years, liquid crystal displays have gained widespread use. Demand has increased for a position-detecting apparatus combined with a liquid crystal display to allow the user to input a desired drawing position directly onto the LCD with a pen. However, these position-detecting apparatuses have problems in that stable signal detection cannot be obtained due to the generation of noise from the liquid crystal display device or the like. In an effort to overcome this problem, the power of the signal transmitted from the tablet has typically been strengthened or increased in order to try to reduce the influence of noise.

In a conventional position-detecting apparatus, position detection has been performed as follows. A resonance circuit in a position-indicating device is allowed to resonate with an electromagnetic wave at a specific frequency sent from a tablet. In turn, the resonant signal is then received by the tablet from the position-indicating device (see, for example, Japanese Unexamined Patent Application Publication No. 63-70326 (JP 63-70326 A)). In other words, in the conventional position-detecting apparatus described in JP 63-70326 A, the resonance circuit of the position-indicating device allows an electromagnetic signal to be sent and received between the tablet and the position-indicating device. The position-indicating device may be cordless or battery-free. Additionally, the position-indicating device is capable of detecting contiguous information data about pen pressure by slightly changing a resonance frequency depending on the pen pressure. However, the conventional position-detecting apparatus of JP 63-70326 A has a disadvantage in that the pen pressure may not be detected in a stable manner, because of a change in the resonance frequency due to the positional relationship between the position-indicating device and the tablet, the influence of a surrounding metal substance, etc. In addition, there is another disadvantage of a limited amount of detectable information.

Therefore, in the position-indicating device, a power supply may be extracted from the resonance signal in the resonance circuit and the extracted power supply may be then used to drive various circuits in the position-indicating device (see, for example, Japanese Unexamined Patent Application Publication No. 7-175572 (JP 7-175572 A) and Japanese Unexamined Patent Application Publication No. 7-200137 (JP 7-200137 A))

JP 7-175572 A describes a position-indicating device including a power supply extraction circuit; a circuit for detecting and converting continuous information, such as pen pressure; an information reply circuit; and a resonance circuit. Thus, continuous information, such as pen pressure, can be detected in the position-detecting apparatus. Additionally, more than one source of continuous information can be detected.

Furthermore, JP 7-200137 A provides a position-indicating device including a power supply extraction circuit, an information reply circuit, and a resonance circuit. Further, the position-indicating device is controllable by an instruction from a tablet. Therefore, a position-detecting apparatus detects ID information specific to the position-indicating device together with the pen pressure.

However, in the position-detecting apparatus as described in JP 7-175572 A and JP 7-200137 A, the strength of the resonant signal generated in the resonance circuit of the position-indicating signal may be absorbed as a power supply in the position-indicating device even though a transmission power from the tablet is increased. Therefore, in order to eliminate the influence of noise, the position-detecting apparatus may require an increase in power consumption because of the need for transmitting a stronger signal from the tablet.

FIG. 1 is a diagram that illustrates a comparison of changes in signal strengths in the resonance circuits of position-indicating devices with respect to increases of transmission power from the tablets in the position-detecting apparatuses described in JP 63-70326 A, JP 7-175572 A, and JP 7-200137 A, respectively. In FIG. 1, graphic line “a” represents the characteristics of the circuit described in JP 63-70326 A and graphic line “b” represents the characteristics of the circuit described in JP 7-175572 A or JP 7-200137 A.

In the circuit of JP 63-70326 A, the signal strength in the resonant circuit increases as the transmission power from the tablet increases. However, in the circuit of JP 7-175572 A or JP 7-200137 A, the rate of increase gradually decreases as the transmission power increases even though the signal strength of the resonance circuit increases. The reason for such behavior can be explained as follows. The circuit described in JP 63-70326 A (line “a”) is provided with the resonance circuit alone while the circuit of JP 7-175572 A or JP 7-200137 A (line “b”) is further provided with a circuit for extracting power supply, thereby allowing the power supply to drive various control circuits in the position-indicating device.

In other words, in the circuits of JP 7-175572 A and JP 7-200137 A (line “b”), a control unit is mainly configured with CMOS circuits, respectively. A power supply current, which is consumed by the CMOS circuit, increases in proportion to an increase in power supply voltage. Thus, an increase in the transmission power from the tablet leads to an increase in the power supply voltage extracted in the position-indicating device. In this case, however, the power supply current also increases. Thus, an increase in voltage stored in a power supply capacitor is thus suppressed by an increase in power consumption. Similarly, as a result, an increase in the signal voltage of the resonance signal in the resonant circuit is small.

### SUMMARY OF THE INVENTION

The present invention provides a position-detecting apparatus and a position-indicating device, each of which is capable of correctly detecting a coordinate position and other continuous information such as pen pressure and information specific to the position-indicating device with low transmission power and without influence of external noise.

A position-detecting apparatus is provided. The position-detecting apparatus includes a tablet for transmitting an electromagnetic wave and a position-indicating device for generating a transmission signal based on the electromagnetic wave received from the tablet. The position-indicating device indicates a position on the tablet to be detected by the position-detecting apparatus. The position-indicating device includes: a resonance circuit having a coil and a capacitor; a power supply extraction unit including a rectifying device and a charging capacitor, which extracts a first power supply from an induction voltage introduced on the coil; an information reply unit, which transmits information as a reply from the position-indicating device to the tablet; and a voltage conversion unit, which generates a second power supply having a predetermined voltage level which is lower than the first power supply extracted by the power supply extraction unit. The charging capacitor is charged when a voltage generated to the resonance circuit is higher than a voltage retained in the charging capacitor. The information reply unit transmits the information as a reply from the position-indicating device by controlling the resonance circuit based on a control signal generated by a transistor circuit operated by the second power supply.

The position-indicating device further includes an operation information detecting unit for detecting at least pen pressure and/or a switch operation. In addition, the operation information detecting unit may be operated by the second power supply.

A position-indicating device for indicating a position on a tablet by transmitting a transmission signal to the tablet upon receiving an electromagnetic wave transmitted from the tablet. The position-indicating device includes: a resonance circuit having a coil and a power supply extraction unit, which extracts a first power supply from an induction voltage introduced on the coil; an information reply unit, which transmits predetermined information as a reply to the tablet and a voltage conversion unit, which generates a second power supply having a predetermined voltage level lower than the first power supply extracted by power supply extraction unit.

The power supply extraction unit includes at least a rectifying device and a charging capacitor. The charging capacitor is charged when a voltage generated to the resonance circuit is higher than a voltage retained in the charging capacitor.

The information reply unit transmits the information as a reply from the position-indicating device by controlling the resonance circuit based on a control signal generated by a transistor circuit operated by the second power supply.

The position-indicating device according to the above-described embodiment further includes an operation information-detecting unit, which includes a transistor circuit for detecting at least pen pressure and/or a switch operation. The operation information-detecting unit may be operated by the second power supply.

A position-indicating device for communication with a digitizer tablet device is also provided. The position-indicating device includes a resonant circuit for receiving a transmission signal from the tablet and a power extraction unit for extracting a voltage of the received transmission signal. A power supply unit in communication with the power extraction unit powers electronic components of the position-indicating device. A voltage regulation unit regulates transfer of power between the power extraction unit and the power supply unit based on minimum power consumption specifications of the electronic components of the position-indicating device.

A position detecting apparatus is also provided. A tablet having a position detection unit with a plurality of loop coils transmits a transmission signal. A position-indicating device includes a resonant circuit for interacting with the loop coils and receiving the transmission signal. A power management unit extracts power from the transmission signal received at the resonant circuit, allocates a first amount of power for powering internal circuitry of the position-indicating device and a second amount of power for generating a response signal for transmission back to the tablet. The first amount of power is maintained constant regardless of transmission power of the transmission signal received from the tablet.

A method of operating a position-indicating device for wireless communication with a digitizer tablet is also provided. The method includes receiving a transmission signal from the tablet onto a resonant circuit in the position-indicating device and extracting a voltage of the transmission signal using a rectifying device and a first capacitor for storing the extracted voltage. A power supply operation is performed for powering internal circuitry of the position-indicating device using a power supply voltage stored on a second capacitor in communication with the first capacitor. Transfer of power between the first capacitor and the second capacitor is regulated so that the power supply voltage stored by the second capacitor is maintained constant regardless of the extracted voltage stored on the first capacitor.

According to the embodiments of the present invention, a position-detecting apparatus and a position-indicating device include a power supply extraction unit for extracting a power supply from a voltage generated in the resonance circuit of the position-indicating device. In addition, a voltage conversion unit converts the extracted power supply into a predetermined lower voltage. Thus, the circuits in the position-indicating device are driven by the converted predetermined lower voltage, so that an electric power consumed in the position-indicating device can be kept at constant, regardless of the level of transmission power from the tablet. Consequently, electric power consumed in the position-indicating device can be controlled to be minimum value at any time by suppressing a circuit-driving voltage as low as possible.

Therefore, even if the transmission power from the tablet has less strength, a strong signal may be detected from the position-indicating device. In addition, even when combining the position-detecting apparatus with a liquid crystal display panel or the like, there is no need to increase the transmission power as in the conventional position detecting apparatuses described above. Thus, the coordinate position and continuous information about operation of the position-indicating device can be stably detected without being influenced by the positional relationships between the tablet and the position-indicating device, the surrounding metal substance, etc. Furthermore, a position-detecting apparatus and a position-indicating device, which are capable of detecting pen pressure, ID information specific to the position-indicating device, and other information is also provided.

### BRIEF DESCRIPTION OF THE DRAWINGS

FIG. 1 is a graph illustrating the relationship between transmission power of a conventional position-detecting apparatus and signal strength of a conventional position-indicating device.

FIG. 2 is a block diagram illustrating a position-indicating device according to an embodiment of the present invention.

FIG. 3 is a perspective view with portions broken away illustrating the position-indicating device shown in FIG. 2.

FIG. 4 is a schematic circuit diagram illustrating a tablet of a position-detecting apparatus according to another embodiment of the present invention.

FIG. 5 is a schematic circuit diagram illustrating a position-indicating device according to another embodiment of the present invention.

FIG. 6 is a signal timing diagram for illustrating operations of the position-detecting apparatus and the position-indicating device according to an embodiment of the present invention.

FIG. 7 is a signal timing diagram for illustrating operations of the position-detecting apparatus and the position-indicating device according to another embodiment of the present invention.

FIG. 8 is a graphic diagram illustrating characteristics of the position-detecting apparatus and the position-indicating device according to an embodiment of the present invention.

FIG. 9 is a graphic diagram illustrating characteristics of the position-detecting apparatus and the position-indicating device according to an embodiment of the present invention.

### DESCRIPTION OF THE PREFERRED EMBODIMENT(S)

Reference will now be made in detail to the embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification.

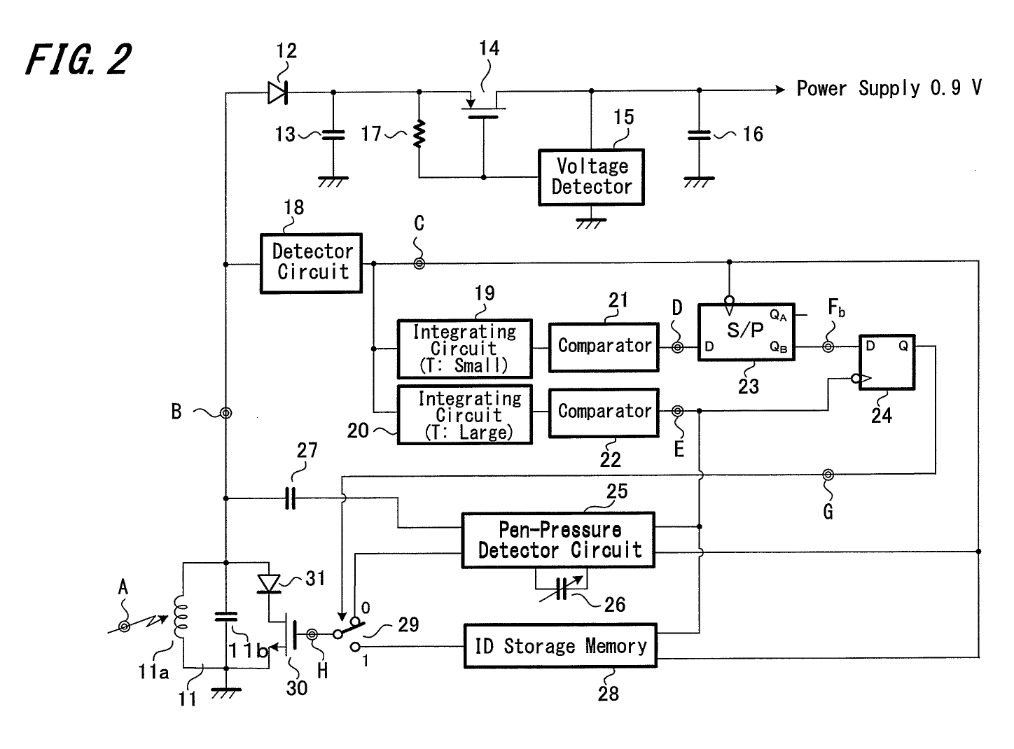

First, FIG. 2 is a block diagram that illustrates a position-indicating device of a position-detecting apparatus according to an embodiment of the present invention. The position detecting apparatus may be a digitizer or graphics tablet including a tablet and the position-indicating device. The tablet may be integrated with a display panel, such as an LCD.

As shown in FIG. 2, the position-indicating device includes: a resonance circuit 11, a diode 12, a power extraction capacitor 13, a P-channel MOSFET 14, a voltage detector 15, a power supply capacitor 16, and a resistor 17. The resonance circuit 11 having a predetermined resonance frequency f0 includes a coil 11a and a capacitor 11b. The diode 12 and power extraction capacitor 13 constitute a power supply extraction unit. The P-channel MOSFET 14, voltage detector 15, power supply capacitor 16, and the resistor 17 constitute a voltage conversion unit. The voltage stored in the power supply capacitor 16 is supplied as a power supply to each circuit described below.

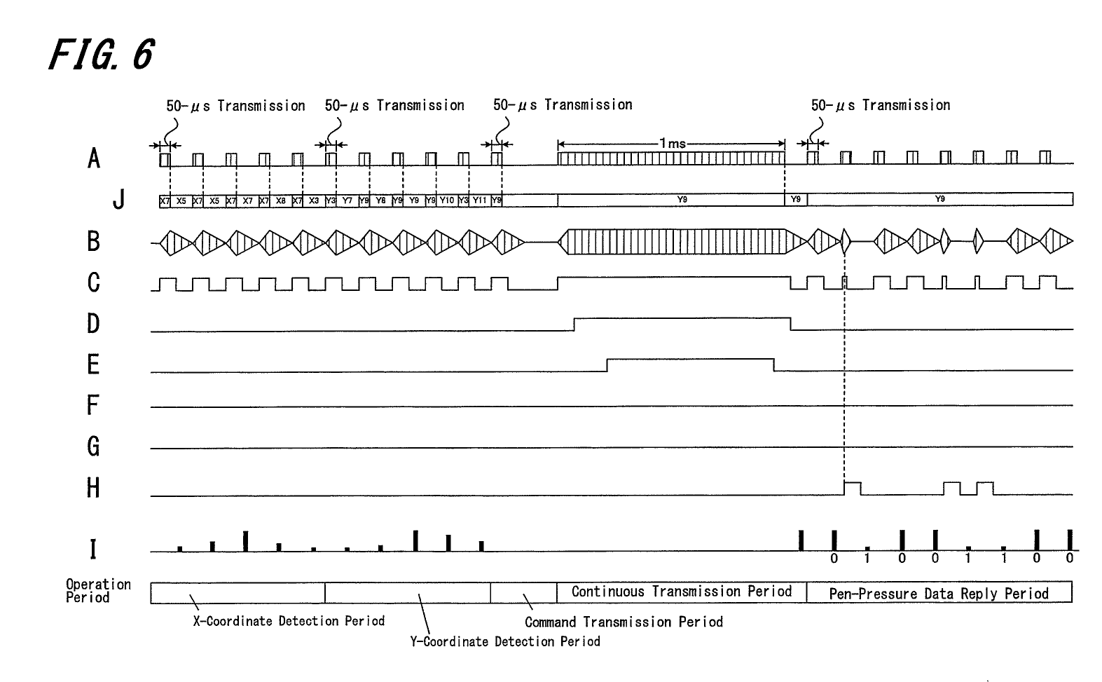

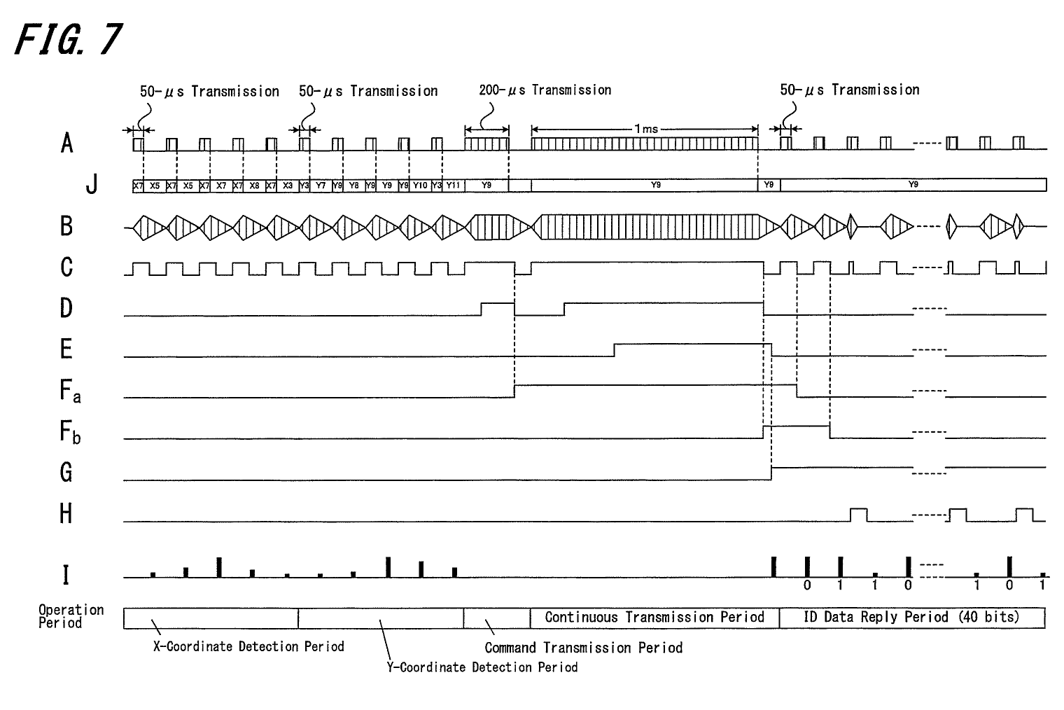

The position-indicating device further includes: a detector circuit 18, a first integrating circuit 19 and a second integrating circuit 20, a first comparator 21 and a second comparator 22, a serial/parallel converter 23, and a D flip-flop 24. The detector circuit 18 generates a clock signal having pulses that correspond to periods of signal transmission and interruption from the tablet or the position-indicating device, as will be described below with reference to FIGS. 6 and 7. The first integrating circuit 19 and second integrating circuit 20 have different time constants, respectively. Here, the time constant of the second integrating circuit 20 is set to be larger than that of the first integrating circuit 19. The first comparator 21 compares an output signal from the first integrating circuit 19 to a first threshold voltage to convert the output signal into an output digital signal. The first threshold voltage used by the first comparator 21 may be 50% of a power supply voltage. For example, the power supply voltage may be 0.9V, and the first threshold may be 0.45V.

Similarly, the second comparator 22 compares an output signal from the second integrating circuit 20 to a second threshold voltage to convert the output signal into an output digital signal. The second threshold voltage used by the second comparator 22 may be 50% of a power supply voltage. For example, the power supply voltage may be 0.9V, and the second threshold may be 0.45V. According to the present embodiment, the time constant of the first integrating circuit 19 and the time constant of the second integrating circuit 20 can be determined based on the following consideration. The output of the first comparator 21 is logic high when the duration of transmission exceeds about 100 μs, while the output of the second comparator 22 is logic high when the duration of transmission exceeds about 300 μs.

The serial/parallel converter 23 includes a 2-bit shift resister. The serial/parallel converter 23 receives an output value from the first comparator 21 every falling edge of the clock pulse received from the detector circuit 18. Further, the D flip-flop 24 retains and outputs a value from a second-bit output Q_{B} of the serial/parallel converter 23 upon the falling edge of the output of the second comparator 22 (see FIG. 7).

Furthermore, the position-indicating device includes: a pen-pressure detector circuit 25, a variable capacitor 26, a capacitor 27, an ID storage memory 28, a switch 29, and an N-channel MOSFET 30. The pen-pressure detector circuit 25 converts pen pressure applied on the variable capacitor 26, in which the capacitance thereof varies depending on the pen pressure, into a digital value and sequentially outputs the results in response to clock pulses from the detector circuit 18 when the switch 29 is selecting the pen-pressure detector circuit 25. The pen-pressure detector circuit 25 digitizes a charging time or a discharging time at a time-constant circuit formed of the variable capacitor 26 by counting signals of frequency f0 input through the capacitor 27. It should be noted that the principle of operation of detecting the pen pressure is known, as described in JP 7-175572 A. Thus, a description thereof will not be provided.

The ID storage memory 28 stores ID information specific to the position-indicating device. The ID information may be 40 bits, and may be used to distinguish among a plurality of position-indicating devices usable with the tablet. The ID information is sequentially output in response to clock pulses from the detector circuit 18 when the switch 29 is selecting the ID storage memory 28.

The switch 29 selects one of the pen-pressure detector circuit 25 and the ID storage memory 28 depending on an output value from the D flip-flop 24. For example, when the output of the flip-flop 24 is “0”, the pen-pressure detector circuit 25 is selected to output the pen pressure. Similarly, when the output of the flip-flop 24 is “1”, the ID storage memory 28 is selected to output the unique ID information associated with the position-indicating device. The switch 29 supplies the selected output to a gate terminal of the N-channel MOSFET 30.

The MOSFET 30 is connected to both ends of the resonance circuit 11 through a diode 31. The diode 31 is provided for preventing a signal of the resonance circuit 11 from leaking by a parasitic diode that exists between a drain terminal and a source terminal of the MOSFET 30. The various circuit components shown in FIG. 2 may be configured with CMOS circuits.

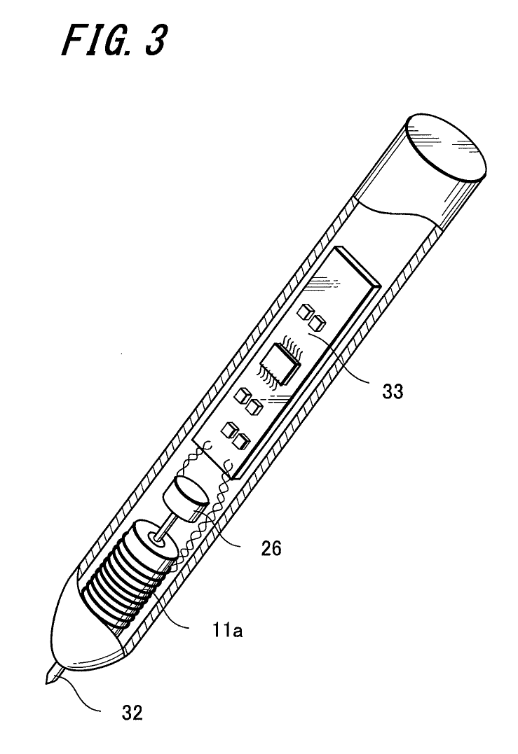

FIG. 3 illustrates the structure of the position-indicating device shown in FIG. 2. The position-indicating device may be a pen-shaped stylus having an outer tubular housing and a pen tip 32 disposed at the end of the housing. Here, the coil 11a is wound around a cylindrical ferrite material. A pen-pressure detecting member 26 corresponds to the variable capacitor 26 shown in FIG. 2 in which the capacitance thereof can vary with pressure on the pen tip 32. The pressure applied to the pen tip 32 is transmitted to the variable capacitor 26 through a hollow part of the coil 11a. In addition, although not shown in FIG. 3, each of the circuit components shown in FIG. 2 is mounted on a circuit board 33.

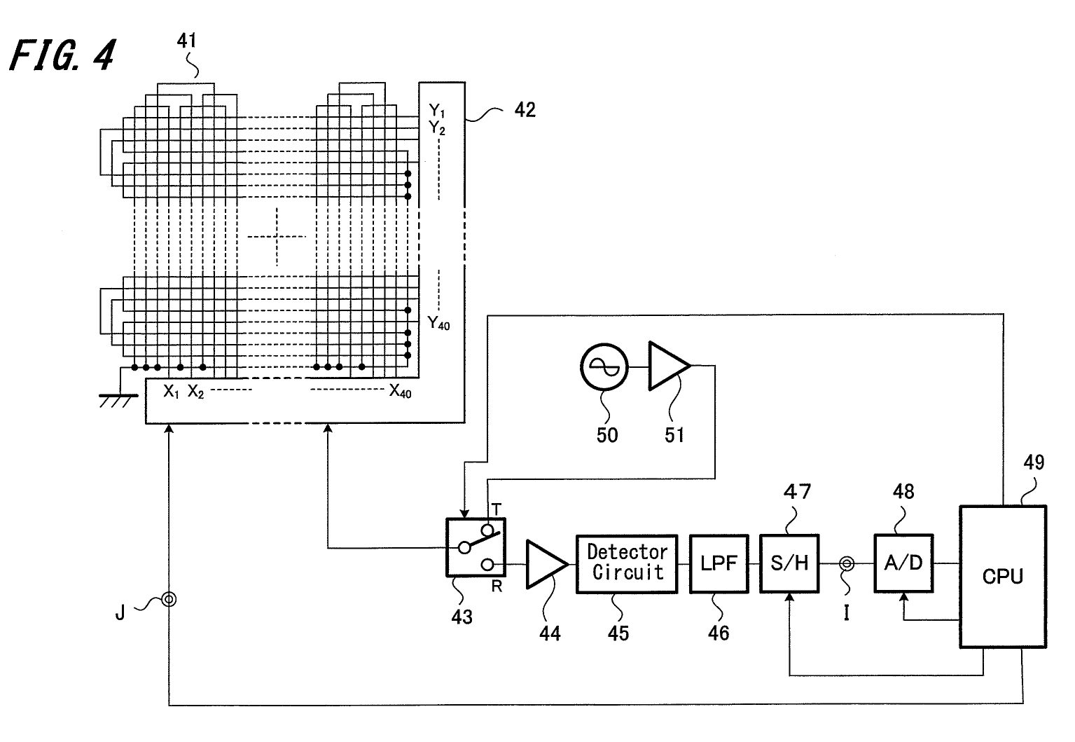

FIG. 4 illustrates the configuration of the tablet of the position-detecting apparatus according to an embodiment of the present invention. As shown in FIG. 4, 40 loop coils X1 to X40 in the X-axis direction and 40 loop coils Y1 to Y40 in the Y-axis direction are arranged in a position-detecting unit 41. These loop coils are connected to a selection circuit 42 configured to select the respective loop coils. It will be appreciated that the position detecting unit 41 can be implemented using other numbers of loop coils.

The selection circuit 42 is connected to a transmit/receive switching circuit 43. A receiving side of the transmit/receive switching circuit 43 is connected to an amplifier 44. The amplifier 44 is connected to a detector circuit 45. The detector circuit 45 is connected to a low-pass filter 46. The low-pass filter 46 is connected to a sample-and-hold circuit 47. The sample-and-hold circuit 47 is connected to an A/D converting circuit 48. Subsequently, the A/D converting circuit 48 is connected to a central processor unit (CPU) 49.

Control signals from the CPU 49 are supplied to the selection circuit 42, the sample-and-hold circuit 47, the A/D converting circuit 48, and the transmit/receive switching circuit 43, respectively. In addition, the position-detecting apparatus according to the present embodiment further includes an oscillator 50 that generates an alternating-current (AC) signal with a frequency of ft, i.e., the resonant frequency of the resonance circuit 11 of the position indicating device shown in FIGS. 2 and 3, and a current driver 51 that converts the AC signal into a current. Thus, upon receiving a control signal from the CPU 49, the transmit/receive switching circuit 43 is switched to transmit the AC signal with the frequency of f0 from the position-detecting unit 41 to the position-indicating device best shown in FIGS. 2 and 3.

Once the tablet shown in FIG. 4 transmits the AC signal to the position-indicating device for a predetermined period, the tablet receives a response signal (position indicating signal) remaining in the resonance circuit 11 of the position-indicating device and calculates the coordinate value of an indicated position. The coordinate detection operation may be performed by detecting the signal strength(s) of the position-indicating signal received at various loop coils of the position-detecting unit 41.

The operation of a power supply circuit portion of the position-indicating device will now be described. Referring back to FIG. 2, the power supply capacitor 16 retains a voltage about equal to a voltage detected by the voltage detector 15. The power supply capacitor 16 then supplies this retained voltage as a power supply to each processing circuit as described below. The power supply voltage may be set to 0.9 V. Here, the voltage detector 15 may be in the form of an open-drain output. The output terminal of the voltage detector 15, which is connected to the gate terminal of the P-channel MOSFET 14, is in a Hi-impedance state when an input voltage (the voltage of the power supply capacitor 16) is 0.9 V or more. In contrast, a Lo level (0 V) is output to the P-channel MOSFET 14 when the voltage is less than 0.9 V.

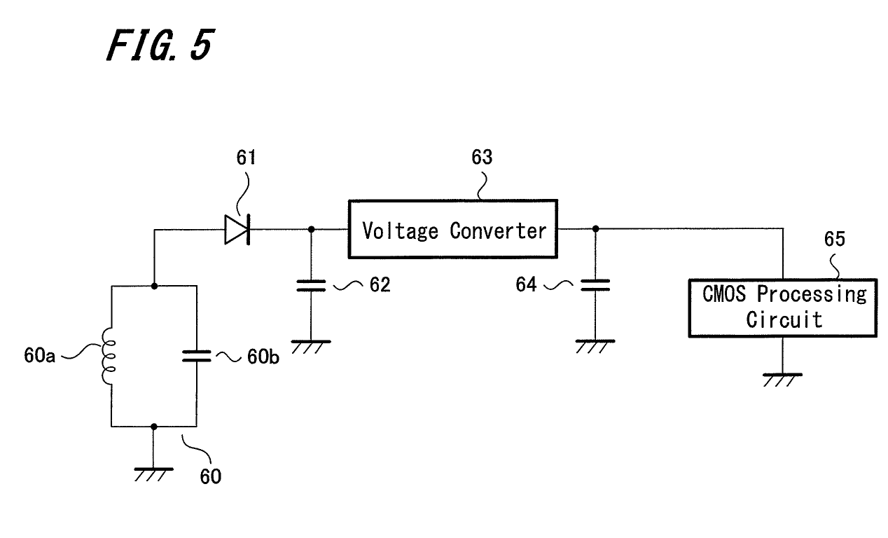

If the voltage of the power supply capacitor 16 decreases slightly less than 0.9 V, the voltage detector 15 outputs the Lo-level to the P-channel MOSFET 14, thereby turning on the MOSFET 14. The power extraction capacitor 13 of the power extraction unit, which extracts power of a transmission signal transmitted by the tablet and received by the resonance circuit 11, retains a voltage higher than 0.9 V so as to charge the power supply capacitor 16 through the MOSFET 14, which is in an on state to provide a logic high voltage to the gate terminal of the P-channel MOSFET 14. When the voltage of the power supply capacitor 16 reaches 0.9 V or more, the output of the voltage detector 15 to the MOSFET 14 immediately turns to a Hi-impedance state. Thus, the MOSFET 14 is turned off, and the power supply capacitor 16 does not continue charging from the power extraction capacitor 13 through the MOSFET 14. Consequently, the voltage of the power supply capacitor 16 is maintained at about 0.9 V due to regulation of the voltage by the voltage detector 15. Additionally, because only the necessary charge on power extraction capacitor 13 is used to maintain the voltage of the power supply capacitor 16 at about 0.9V, less power is consumed and the strength of the position-indicating signal transmitted from the position-indicating device back to the tablet is not weakened due to unnecessary power consumption. Moreover, the power consumption remains relatively constant, regardless of the distance between the tablet and the position-indicating device. FIG. 5 illustrates a basic configuration of a position-indicating device according to another embodiment of the present invention. As shown in FIG. 5, a resonance circuit 60 includes a coil 60a and a capacitor 60b. A diode 61 and a power extraction capacitor 62 constitute a power supply extraction unit. A voltage converter 63 and a power supply capacitor 64 constitute a voltage conversion unit.

Furthermore, a CMOS processing circuit 65 outputs a control signal for controlling the resonance circuit 60 at a predetermined timing in response to one or more information signals. It should be noted that the control signal from the CMOS processing circuit 65 to the resonance circuit 60 is not shown in FIG. 5 for simplification purposes. The information signals may include information about detection of pen pressure, information about operation of a switch disposed on the position-indicating device, information about the operation of the position-indicating device, ID information specific to the position-indicating device, or the like. Accordingly, the CMOS processing circuit 65 can modulate the position-indicating signal of the resonance frequency f0 transmitted from the resonance circuit 60 to the position-detecting unit 41 of the tablet shown in FIG. 4 with the one or more information signals described above.

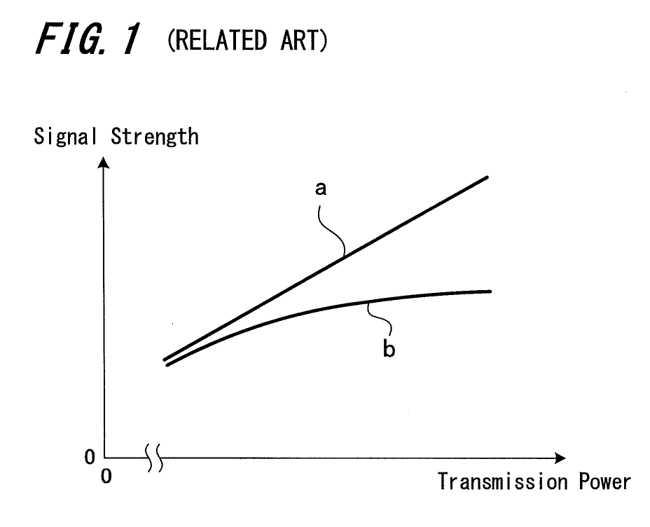

A voltage output from the voltage converter 63 is the lowest voltage at which the processing circuit 65 can be driven. In other words, the voltage converter 63 receives the voltage from the power supply extraction unit, which varies based on the position of the position-indicating signal with respect to the tablet, and outputs a constant voltage at the minimum driving voltage for the processing circuit 65. Thus, the electric power consumed by the processing circuit 65 can be minimized regardless of a signal strength generated in the resonance circuit 60. Therefore, in this circuit, an increase in transmission power from the tablet proportionally leads to an increase in the voltage extracted by the diode 61 and the power extraction capacitor 62 of the power supply extraction unit. Thus, signal voltage generated in the resonance circuit 60 for transmitting the position-indicating signal back to the tablet is also increased. Accordingly, as shown in FIG. 1, a relationship that approximates line “a” can be obtained.

As described above, a voltage for driving circuits may be minimized in order to reduce electric power consumed in the position-indicating device. Therefore, even if the transmission power from the tablet is weak, for example, if the position-indicating device is relatively far from the tablet surface, a strong signal may be transmitted in response from the position-indicating device and detected by the tablet, because more voltage is retained by the power extraction capacitor 62 instead of being consumed by the CMOS processing circuit 65. In addition, when a liquid crystal panel is combined with the position-detecting apparatus, a coordinate position can be stably detected. Furthermore, the continuous information (pen pressure, ID information, switch operation, etc.) transmitted by the position-indicating signal can be detected without being influenced by the positional relationship between the tablet and the position-indicating device, the surrounding metal substance, etc.

Furthermore, according to the present embodiment of the invention, the tablet transmits a control signal requesting specific information to the position-indicating device. In response, the position-indicating device selects one of pen-pressure information and ID information specific to the position-indicating device and then sends a reply signal containing this specific information to the tablet. FIG. 6 illustrates an operation performed upon a request for pen-pressure information sent from the tablet to the position-indicating device. In FIG. 6, symbols “A” to “J” represent waveforms at locations in the position-indicating device of FIG. 2 and the tablet of FIG. 4, which are indicated by the same symbols.

Specifically, symbol “A” denotes a tablet transmission signal or a position indicating signal transmitted from the position-indicating device to the position-detecting unit 42 of the tablet, symbol “B” denotes voltages at both ends of the resonance circuit 11, symbol “C” denotes an output from the detector circuit 18, symbol “D” denotes an output from the first comparator 21, symbol “E” denotes an output from the second comparator 22, symbol “F” denotes an output from the serial/parallel converter 23 Qb, symbol “G” denotes a control signal for the switch 29, symbol “H” denotes a control signal for the MOSFET 30, symbol “I” denotes a signal input to the A/D converter 48 in the tablet, and symbol “J” denotes the tablet-coil selection number output from the CPU 49. Hereinafter, the operation of the position-indicating device and the tablet will be described. It will be assumed that the position-indicating device is initially positioned at the intersection between the loop coil X7 and the loop coil Y9 on the position-detecting unit 41 of the tablet.

The CPU 49 of the tablet performs alternating operations of transmission and reception five times to obtain the X coordinate of the position-indicating device during the X-coordinate detection period. As best shown in FIG. 6, the loop coil X7 proximate to the position-indicating device is selected when performing the transmission operation, while the loop coils X5 to X9 are sequentially switched when performing the reception operation. The CPU 49 obtains signal levels detected from five loop coils (X5, X6, X7, X8, and X9) with a center on the loop coil X7 based on these five transmission/reception operations in order to determine current position information of the position-indicating device.

As represented by the symbol I in FIG. 6, among these signal levels, the highest signal level is obtained when selecting the loop coil X7 and receiving the signal thereof. The signal levels decrease as the distance from the loop coil X7 increases. The CPU 49 calculates an X-coordinate value indicated by the position-indicating device by referring to the signal level distribution.

Subsequently, the CPU 49 performs alternating operations of transmission and reception five times to obtain the Y coordinate of the position-indicating device during the Y-coordinate detection period. In this case, the loop coil Y9 proximate to the position-indicating device is selected when carrying out the transmission, while the loop coils Y7 to Y11 are sequentially switched when carrying out the reception. The CPU 49 obtains the Y coordinate value in a manner similar to when detecting the X-coordinate value.

Furthermore, in the operations for detecting the X coordinate and the Y coordinate, when the peak of the signal levels from the respective five loop coils has deviated from the central number, i.e., X7 or Y9, it is determined that the position-indicating device has moved and the number of the loop coil having a peak level is updated to the loop coil proximate or closest to the position-indicating device. Accordingly, the loop coil used to transmit information to the position-indicating device may be updated to the newly determined proximate loop coil.

Subsequently, the CPU 49 selects the updated loop coil number proximate to the position-indicating device in the operation of detecting the Y coordinate so that a command signal that requests pen-pressure information may be transmitted from the position detecting unit 41 to the position-indicating device. Here, because the loop coil Y9 has the peak signal level (refer to symbol “I” in FIG. 6), loop coil Y9 is selected and the transmission with a time-duration of 50 μs is performed during the command transmission period. This transmission time is sufficiently shorter than the time constant of the first integrating circuit 19, therefore the output of the first comparator 21 is logic low “0”. Thus, there is no chance of storing a “1” in the serial/parallel converter 23 and the output of the D flip-flop 24 retains a “0”. Thus, the switch 29 is in a state of selecting the output side of the pen-pressure detector circuit 25 during the period of data reply as described below.

Subsequently, a continuous transmission with a time-duration of about 1 ms is performed in a state of selecting the loop coil Y9 during the continuous transmission period best shown in FIG. 6. The continuous transmission defines a command transmitted immediately prior to the continuous transmission and also determines the timing when the data reply of the position indicating device begins as described below. In addition, the operations of detecting the pen pressure and converting the pen pressure into a digital value may be performed during the continuous transmission period. Upon completing the continuous transmission of 1 ms, the CPU 49 performs the reception operation in a state of selecting the loop coil Y9 (the closest or proximate loop coil). The CPU 49 stores a value of half the signal level detected at this time at the loop coil Y9 as a reference level for the data detection as described below.

Subsequently, the CPU 49 alternately performs a transmission at a time-duration of 50 μs and a reception at a time-duration of 100 μs, eight times in total. The eight cycles of transmission/reception detect 8-bit pen-pressure data sequentially transmitted from the pen-pressure detector circuit 25. In other words, as best shown at symbol “I” in FIG. 6, the data is stored as a “0” when the level detected by the transmission/reception is higher than the previously stored reference level, while the data is stored as a “1” when the level is lower than the reference level. The eight transmission/reception operations allow the CPU 49 to determine the pen pressure on the variable capacitor 26 as a digital value of 8 bits. It should be understood that the pen-pressure data need not necessarily be represented using 8 bits, but instead may be represented using a larger or smaller number of bits.

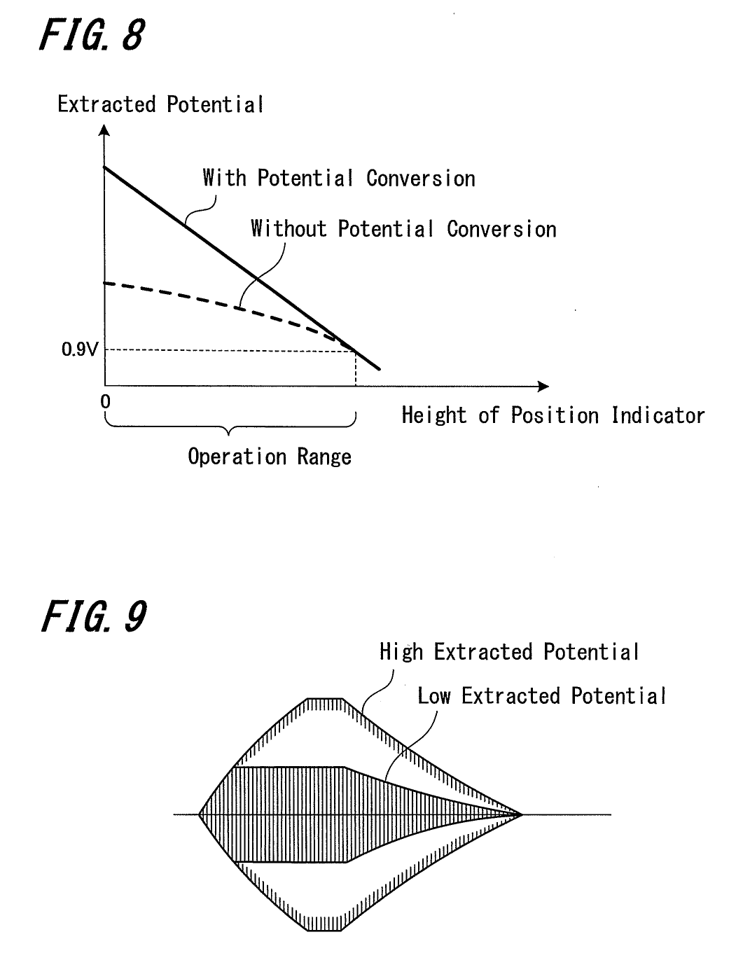

FIG. 7 illustrates the operation of the tablet when the tablet requests transmission of specific ID information from the position-indicating device. FIG. 7 illustrates the same operation as that of FIG. 6, except that the time-duration of the command transmission is 200 μS and the number of transmission/reception repetitions when performing data reception is forty times for forty bits of data associated with the specific ID of the position-indicating device. Based on the length of the command transmission, the position-indicating device can distinguish between various types of requested information. Additionally, symbol “Fa” in FIG. 7 denotes an output from the serial/parallel converter 23 Qa, and symbol “Fb” in FIG. 8 denotes an output from the serial/parallel converter 23 Qb. It will be appreciated that a larger number or a smaller number of bits may alternatively be used for the specific ID of the position-indicating device. Accordingly, a plurality of position-indicating devices associated with a plurality of different IDs may be used with the tablet.

After about 100 μs from the initiation of command transmission during the command transmission period, the output of the first comparator 21 changes to a Hi level, or logic high “1” due to the relatively small timing constant of the first integrating circuit 19 shown in FIG. 2. After completing the command transmission, the output of the detector circuit 18 falls and then the serial/parallel converter 23 receives the “1” from the first comparator 21 to make the output Q_{A} at the first bit a “1” as indicated by symbol “Fa” shown in FIG. 7. After an additional 1-ms continuous transmission, the output of the detection circuit 18 falls to shift the Q_{A}-output value of the serial/parallel converter 23 to Q_{B} at the second bit as indicated by symbol “Fb” shown in FIG. 7.

Therefore, the Q_{B} terminal of the serial/parallel converter 23 provides a Hi level, logic high “1” as an output. The output of the second comparator 22 rises high when about 300 μs has elapsed from the initiation of the 1-ms continuous transmission due to the relatively large time constant of the second integrating circuit 20 shown in FIG. 2. Shortly after completion of the 1 ms continuous transmission, the output of the second comparator 22 falls low again as indicated by the symbol “E” in FIG. 7. The falling edge allows the D flip-flop 24 to change a control signal to the switch 29 from “0” to “1” as indicated by symbol “G” in FIG. 7.

These operations control the switch 29 to select the ID storage memory 28. In this case, a 40-bit unique ID stored in the ID storage memory 28 of the position-indicating device is sequentially output in synchronization with clock pulses output from the detector circuit 18.

The CMOS technology used in the position-indicating device shown in FIG. 3 has the lowest power consumption among various semiconductor technologies. A power supply voltage for the operation of the CMOS circuit may be about 0.9 V, which is practically the lowest voltage usable to power this type of electronics. In addition, the level of current consumed by the CMOS current is known to increase in proportion to the power supply voltage. According to the embodiments of the present invention, therefore, a power supply extracted in the position-indicating device can be supplied to the CMOS circuits after being converted into 0.9 V. Because 0.9V is supplied to the CMOS circuits regardless of the strength of the transmission signal received at the position-indicating device, power consumption by the position-indicating device is minimized. Therefore, more power is available to the resonant circuit of the position indicating device for transmission to the tablet.

Here, FIG. 8 illustrates the relationship between the height of the position-indicating device from the tablet surface and the voltage extracted by the power extraction capacitor 13 of the voltage extraction unit of the position-indicating device shown in FIG. 2. In FIG. 8, the thick dashed line corresponds to a typical case in which the voltage conversion to 0.9 V is not performed and a voltage generated in the power extraction capacitor 13 is used as a power supply voltage without modification. As shown in FIG. 8, when the voltage conversion is performed, more potential or power supply can be extracted without this extracted voltage being consumed in the CMOS circuits. Further, FIG. 9 shows that a signal level generated at both ends of the resonance circuit 11, e.g., at point “B” in FIG. 2, at a high voltage is different from a signal level at a low voltage.

As shown in FIG. 9, the signal level of the resonance circuit 11 may increase at a predetermined rate when the signal transmission from the tablet is initiated. Upon reaching to the voltage retained in the power extraction capacitor 13, a signal generated from the resonance circuit 11 is absorbed into the power extraction capacitor 13 through the diode 12. Accordingly, even if successive transmission continues, voltages at both ends of the resonance circuit may not increase, thereby causing a saturated state as shown in FIG. 9. The saturated voltage corresponds to the voltage of the power extraction capacitor 13. The extracted potential may depend on the distance between the tablet and the position-indicating device and the transmission power of the tablet.

The position detecting apparatus according to the embodiments of the present invention maintains a constant power consumption in the position-indicating device regardless of an increase in the transmission power from the tablet. The transmission power may increase as the position-indicating device is moved closer to the tablet. Thus, the voltage extracted in the power extraction capacitor 13 can be enhanced in response to the signal level of transmission from the tablet. In addition, the saturated voltage corresponding to the voltage of the power extraction capacitor 13 can also be enhanced sufficiently. Therefore, the position-detecting apparatus can generate a strong signal in the resonance circuit of the position-indicating device even with less transmission power from the tablet, compared with the conventional position-detecting apparatus described above, while the tablet can detect the strong signal transmitted by the position-indicating device.

In other words, the resonance circuit is provided with a circuit for extracting a power supply having a constant voltage. Because the power consumed by the electronics in the position-indicating device is minimized, the voltage in the resonance circuit can be sufficiently increased and a strong transmission signal can be generated by the position-indicating device. In contrast, the conventional position-detecting apparatus supplies an extracted power supply without any modification to the CMOS circuit. Thus, the more the transmission power from the tablet increases, the more the electric power is consumed in the conventional position-indicating device. As a result, the conventional position-indicating device described above is unable to increase signal strength for replying from the position-indicating device to the tablet.

It should be understood that although the embodiments of the voltage conversion unit include the voltage detector and the MOSFET, this description is not intended to limit the scope of the present invention. In addition, although the power supply extraction unit is shown and described as including the capacitor together with one diode, it will be appreciated that the power supply extraction unit may employ two diodes or any of other rectifying devices.

In the above-described embodiments, the position-indicating device replies to information requests by switching between pen-pressure data and unique-ID data in response to a command received from the tablet. Alternatively, the command need not be transmitted or any information about a switch or the like may be replied.

In addition, although not shown in FIG. 3, a switch may be mounted on the side of the position-indicating device to make a reply by transmission of information about the switch operation state subsequent to the pen-pressure data.

In addition, in the above-described embodiments, the data in the reply is applied by a short circuit to the resonance circuit. Alternatively, the data in the reply may be applied by slightly changing the resonance frequency or controlling any of the other characteristics of the resonance circuit. In addition, the replying data is not necessarily in a digital form. The reply may be carried out by any method, such as one for modulating or continuously changing the frequencies or amplitudes of signals generated in the resonance circuit.

Furthermore, in the above-described embodiments, the coil for transmission from the tablet may be the same as the receiving coil. Alternatively, a coil dedicated for transmission may be used with the tablet.

Although embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A position-detecting apparatus, comprising:
a tablet for transmitting an electromagnetic wave; and
a position-indicating device for receiving the electromagnetic wave from the tablet and for generating a transmission signal for indicating a position on the tablet, the position-indicating including
a resonance circuit having a coil and a capacitor;
a power supply extraction unit including a rectifying device and a charging capacitor configured to extract a first power supply from a voltage introduced on the coil, the charging capacitor being charged when a voltage generated in the resonance circuit is higher than a voltage retained in the charging capacitor;
an information reply unit configured to transmit information as a reply from the position-indicating device to the tablet; and
a voltage conversion unit configured to generate a second power supply having a predetermined voltage level which is lower than the first power supply extracted by the power supply extraction unit,
wherein the information reply unit transmits the information as a reply from the position-indicating device by controlling the resonance circuit based on a control signal generated by a transistor circuit operated by the second power supply.

2. The position-detecting apparatus according to claim 1, wherein the position-indicating device further includes an operation information detecting unit for detecting at least pen pressure and/or switch operation, and the operation information detecting unit is operated by the second power supply.

3. A position-indicating device for indicating a position on a tablet by generating a transmission signal to the tablet upon receiving an electromagnetic wave transmitted from the tablet, the position-indicating device comprising:
a resonance circuit having a coil and a capacitor;
a power supply extraction unit including a rectifying device and a charging device configured to extract a first power supply from an induction voltage introduced into the coil, the charging capacitor being charged when a voltage generated in the resonance circuit is higher than a voltage retained in the charging capacitor;
an information reply unit configured to transmit predetermined information as a reply to the tablet; and
a voltage conversion unit configured to generate a second power supply having a predetermined voltage level which is lower than the first power supply extracted by the power supply extraction unit,
wherein the information reply unit transmits the information as a reply from the position-indicating device by controlling the resonance circuit based on a control signal generated by a transistor circuit operated by the second power supply.

4. The position-indicating device according to claim 3, further comprising:
an operation information detecting unit including configured to detect at least pen pressure and/or switch operation, the operation information detecting unit being operated by the second power supply.

5. A position indicating device for communication with a digitizer tablet device, the position indicating device comprising:
a resonant circuit for receiving a transmission signal from the tablet;
a power extraction unit for extracting a voltage of the received transmission signal;
a power supply unit in communication with said power extraction unit for powering electronic components of the position-indicating device; and
a voltage regulation unit for regulating transfer of power between said power extraction unit and said power supply unit based on minimum power consumption specifications of the electronic components of the position-indicating device.

6. The position-indicating device according to claim 5, wherein said power extraction circuit comprises:
a rectifying component for receiving an alternating power signal from said resonant circuit and rectifying the power signal; and
a power extraction capacitor receiving the rectified signal and for charging up to the extracted voltage.

7. The position indicating device according to claim 5, wherein said voltage regulation unit comprises a voltage conversion unit for converting the extracted voltage to a minimum driving voltage for driving the electronic components of the position-indicating device.

8. The position indicating device according to claim 7, wherein said voltage conversion unit comprises:
a voltage detector for detecting a voltage at said power supply unit;
a switch in communication with said voltage detector, said switch being turned ON when the voltage at said power supply unit is below the minimum driving voltage so that current flows between said power extraction unit and said power supply unit, and said switch being turned OFF when the voltage at said power supply unit is greater than or equal to the minimum driving voltage so that no current flows between said power extraction unit and said power supply unit.

9. The position indicating device according to claim 8, wherein said switch comprises a MOSFET having a gate terminal connected to said voltage detector, a source terminal connected to said power extraction unit, and a drain terminal connected to said power supply unit.

10. The position indicating device according to claim 5, wherein:
said power extraction unit comprises a power extraction capacitor for retaining the extracted voltage; and
said power supply unit comprises a power supply capacitor for retaining the power supply voltage, said power supply capacitor being charged by said power extraction capacitor based on operation of said voltage regulation unit.

11. The position indicating device according to claim 5, wherein the electronic components of the position indicating device are CMOS components, and said power supply unit is maintained at a voltage of about 0.9V.

12. The position-indicating device according to claim 5, wherein the extracted voltage of said power extraction unit is used to charge said power supply unit and to generate a response signal in the resonant circuit for transmission to the tablet, in response to the received transmission signal.

13. The position indicating device according to claim 5, further comprising:
an information reply unit for transmitting information about a current operational state of the position-indicating device to the tablet, in response to an information request command received from the tablet.

14. The position indicating device according to claim 13, wherein the position indicating device comprises a stylus with a pen tip for contacting the tablet and at least one switch disposed on the stylus, and the information requested comprises at least one of pressure on the pen-tip of the stylus, switch information associated with said at least one switch, or unique ID information associated with the position-indicating device.

15. The position-indicating device according to claim 5, wherein the position-indicating device comprises a wireless electromagnetic stylus that is powered by the transmission signal of the tablet.

16. The position indicating device according to claim 5, wherein a voltage supplied by said power supply unit to the electronic components is maintained constant by the voltage regulation unit regardless of the voltage extracted by said power extraction unit.

17. The position indicating device according to claim 5, wherein said power extraction unit, said voltage regulation unit, and said power supply unit together constitute a power management unit for extracting power from the transmission signal, allocating a first amount of power for powering internal circuitry of the position-indicating device and a second amount of power for generating a response signal for transmission back to the tablet, said first amount of power being maintained constant regardless of transmission power of the transmission signal received from the tablet.

18. A position detecting apparatus, comprising: a tablet having a position detection unit with a plurality of loop coils, said tablet transmitting a transmission signal; and
a position-indicating device, comprising:
a resonant circuit for interacting with said loop coils and receiving said transmission signal, and
a power management unit for extracting power from the transmission signal received at said resonant circuit, allocating a first amount of power for powering internal circuitry of said position-indicating device and a second amount of power for generating a response signal for transmission back to the tablet, said first amount of power being maintained constant regardless of transmission power of the transmission signal received from the tablet.

19. The position detecting apparatus according to claim 18, wherein said power management unit reduces a voltage extracted from the transmission signal and provides the reduced voltage to the internal circuitry of the position-indicating signal.

20. The position detecting apparatus according to claim 18, wherein the power management unit comprises:
a power extraction unit for extracting a voltage of the transmission signal;
a power supply unit in communication with said power extraction unit for powering the internal circuitry of the position-indicating device; and
a voltage regulation unit for regulating transfer of power between said power extraction unit and said power supply unit based on minimum power consumption specifications of the internal circuitry of the position-indicating device.

21. A method of operating a position-indicating device for wireless communication with a digitizer tablet, the method comprising:
receiving a transmission signal from the tablet onto a resonant circuit in the position-indicating device;
extracting a voltage of the transmission signal using a rectifying device and a first capacitor for storing the extracted voltage;
performing a power supply operation for powering internal circuitry of the position indicating device using a power supply voltage stored on a second capacitor in communication with the first capacitor; and
regulating transfer of power between the first capacitor and the second capacitor so that the power supply voltage stored by the second capacitor is maintained constant regardless of the extracted voltage stored on the first capacitor.
